(19) United States
(12) Patent Application Publication
(10) Pub. No.: US 2005/0047671 A1
(43) Pub. Date: Mar. 3, 2005

(54) [CIRCUIT AND METHOD FOR ENHANCING MOTION PICTURE QUALITY ]

(76) Inventor: Ho-Hsing Yang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,296

(22) Filed: Dec. 4, 2003

(30) Foreign Application Priority Data
Sep. 2, 2003 (TW) 92124166

(51) Int. Cl. G06K 9/40

(52) U.S. Cl. 382/254

(57) ABSTRACT

A circuit structure and method for enhancing motion picture quality are provided. This circuit comprises a frame memory and two dual-port buffers. The memory structure can read the previous frame data and store the present frame data at the same time. Therefore, it can provide a simpler access control and structure of memory than the prior art. The circuit compresses the data by a nonlinear quantization method, which can reduce the size of the frame memory. The circuit uses alternate reading/writing and interpolation by using the adjacent pixels to further reduce the size of the frame memory.

### CROSS REFERENCE TO RELATED APPLICATIONS

This application claims the priority benefit of Taiwan application serial no. 92124166, filed Sep. 2, 2003.

### BACKGROUND OF INVENTION

1. Field of the Invention

This invention generally relates to a driving circuit and method for a display, and more particularly to a circuit and method for enhancing motion picture quality.

2. Description of Related Art

After the liquid crystal was discovered, it has been applied to display devices and other applications. For motion picture display applications, the liquid crystal display (LCD) has the advantages of being light, compact and lower radiation compared to the traditional CRT display and therefore a better choice over the traditional CRT display. A LCD includes a plurality of pixels. The liquid crystal is filled between two substrates. The transmission rate of the liquid crystal then can be changed by applying a voltage on the electrodes on the substrates. Because the liquid crystal is filled between two electrodes, it can be a so-called a liquid crystal capacitor. FIG. 1 is a pixel 100 of a conventional LCD. The thin film transistor (TFT) 130 is controlled by the scan signal 104 to determine whether or not to introduce the image signal 102. The storage capacitor 120 stores the image signal 102 so that it can supply the driving voltage to the liquid crystal capacitor 110 even if the TFT 130 is off. Because the capacitance of the liquid crystal capacitor 110 depends on the direction of the liquid crystal, when the voltage is applied to change the direction of the liquid crystal, the capacitance of the liquid crystal capacitor 110 is also changed.

FIG. 2 shows the relationship between the voltage applied to the liquid crystal capacitor of a pixel |V| and the frame time. The voltage is changed after the nth frame and requires several frames to reach the target voltage. Before the voltage 220 of the liquid crystal capacitor reaches the target voltage 210, this pixel will show an unanticipated gray level for a short period of time. FIG. 3 shows the relationship between the gray level and the frame time for a pixel. As shown in FIG. 3, the pixel is going to change from Black to a target gray level 310 at the nth frame. Due to the characteristics of the liquid crystal, it takes several frames to reach the target gray level 310.

The aforementioned response delay may not be a serious issue for a still image application. However, for a motion picture application, this delay causes a poor quality of the image. Conventionally, the delay can be improved by applying a compensation voltage when changing the voltage applied to the electrodes so that the voltage on the liquid crystal capacitor |V| is higher than the target voltage. Then the voltage applied on the liquid crystal capacitor become normal at the next frame. FIG. 4 shows the conventional method to improve the response delay on the LCD. The voltage |V| is changed at the nth frame and a compensation voltage 430 is also applied so that the voltage 420 of the liquid crystal capacitor can reach the target voltage 410 within the nth frame. FIG. 5 shows the relationship between the gray level and the frame time for a pixel after the conventional method is applied. As shown in FIG. 3, the pixel changes from Black to a target gray level 510 within the nth frame. The voltage 420 of the liquid crystal capacitor can reach the target voltage 410 within the nth frame and without waiting for several frames.

The conventional method for enhancing the motion picture requires comparing a frame data of the previous frame and the frame data of the present frame. If the frame data in the previous frame are different from that of the present frame, a compensation voltage is applied; otherwise, no compensation is applied. This conventional method requires a frame memory to store the frame data of the previous frame. When the frame data of the previous frame is outputted, the frame data of the present frame will be saved. One also can use two frame memory devices to store the frame data of the previous frame and the frame data of the present frame. To reduce the costs, a prior art has been proposed (Taiwan Patent No. 513685 and its corresponding U.S. Pat. No. 2002/0180676) to enhance the motion picture quality. This prior art requires a complex and precious timing control and uses four single-port buffers to store the frame data of the previous and present frames at the same time. To prevent conflict of reading and writing in the prior art, bigger memory devices are required. Further, although the prior art uses a single frame memory to store the frame data of the previous frame, practically the frame memory is still very expensive. Hence, how to reduce the size of the frame memory is an important issue to be concerned.

### SUMMARY OF INVENTION

An object of the present invention is to provide a circuit and method for enhancing motion picture quality to reduce the data of the frame thereby reducing the size of the frame memory.

Another object of the present invention is to provide a circuit and method for enhancing motion picture quality to save the frame data partially and alternately thereby reducing the size of the frame memory.

Still another object of the present invention is to provide a circuit and method for enhancing motion picture quality by using two dual-port buffers to simplify the timing control of the frame memory.

The present invention provides a circuit for enhancing motion picture quality, comprising: a first dual-port buffer for receiving and temporarily storing a first frame data, and first-in-first-out outputting the first frame data; a second dual-port buffer for receiving and temporarily storing a second frame data, and first-in-first-out outputting the second frame data; the first frame data being shown in a motion picture after the second frame data; a frame memory for storing a motion picture data; a multiplexer unit, coupled to said first dual-port buffer, said second dual-port buffer, and said frame memory, for selecting and transmitting one of said outputted said first frame data to said frame memory and said outputted said second frame data to said second dual-port buffer; and a signal converter for obtaining a compensation data to output a third frame data in response to the first frame data and the second frame data corresponding to the first frame data.

In a preferred embodiment of the present invention, the circuit further comprises: a first data latch for receiving a fourth frame data and outputting the first frame data, wherein the number of bits of the first frame data is larger than the number of bits of the fourth frame data; a second data latch for receiving a fifth frame data and outputting the second frame data, wherein the number of bits of the second frame data is larger than the number of bits of the fifth frame data; wherein the signal converter obtains the compensation data to output the third frame data in response to the fourth frame data and the fifth frame data corresponding to the second frame data.

In a preferred embodiment of the present invention, the circuit further comprises a nonlinear quantizer for receiving a sixth frame data and quantizing the sixth frame data by using a nonlinear quantization method to output the fourth frame data, wherein the signal converter is for receiving the sixth frame data and compensating the sixth frame data based on the compensation data to obtain the third frame data.

The present invention provides a circuit for enhancing motion picture quality, comprising: a nonlinear quantizer for receiving a first frame data and quantizing the first frame data by using a nonlinear quantization method to output a second frame data; a frame memory module, coupled to the nonlinear quantizer, for receiving the second frame data and outputting a third frame data corresponding to the second frame data, the second frame data being shown in a motion picture after the third frame data; and a signal converter, in response to the second frame data and the third frame data corresponding to the second frame data, for obtaining a compensation data to compensate the first frame data for outputting a fourth frame data.

In a preferred embodiment of the present invention, the frame memory module comprises: a first dual-port buffer for receiving and temporarily storing the second frame data, and first-in-first-out outputting the second frame data; a second dual-port buffer for receiving and temporarily storing the third frame date, and first-in-first-out outputting the third frame data; a frame memory for storing a motion picture data; and a multiplexer unit coupled to said first dual-port buffer, said second dual-port buffer and said frame memory; for selecting and transmitting one of said outputted said second frame data to said frame memory and said outputted said third frame data to said frame memory to said second dual-port buffer.

In a preferred embodiment of the present invention, the signal converter comprises: a motion picture enhancing unit for simultaneously receiving the second frame data and the third frame data and comparing the second frame data and the second frame data to generate the compensation data based on the difference between the second frame data and the third frame data; and a data processing unit for simultaneously receiving the first frame data and the compensation data corresponding to the first frame data, and compensating the first frame data based on the compensation data to obtain the fourth frame data.

The present invention provides a method for enhancing motion picture quality, comprising: providing a first dual-port buffer, a second dual-port buffer, and a frame memory; using the first dual-port buffer to receive and temporarily store a first frame date, and first-in-first-out outputting the first frame data; using the second dual-port buffer to receive and temporarily store a second frame date, and first-in-first-out outputting the second frame data; the first frame data being shown in a motion picture after the second frame data; using the frame memory to store a motion picture data; multiplexing said motion picture data in said frame memory thereby selecting and transmitting one of said outputted said first frame data to said frame memory and said outputted said second frame data to said second dual-port buffer; and obtaining a compensation data to output a third frame data in response to the first frame data and the second frame data corresponding to the first frame data.

The present invention provides a circuit for enhancing motion picture quality, comprising: a first dual-port buffer for receiving and temporarily storing a first frame date, and first-in-first-out outputting the first frame data; a second dual-port buffer for receiving and temporarily storing a second frame date, and first-in-first-out outputting the second frame data; the first frame data being shown in a motion picture after the second frame data; a frame memory for storing a motion picture data; a multiplexer unit, coupled to said first dual-port buffer, said second dual-port buffer, and said frame memory, for selecting and transmitting one of said outputted said first frame data to said frame memory and said outputted said second frame data to said second dual-port buffer; a signal converter, in response to the first frame data, a third frame data, and the second frame data corresponding to the third frame data, for obtaining a compensation data to output a fourth frame data and a fifth frame data; a first data flow switcher receiving a sixth frame data and a seventh frame data and transforming the sixth frame data and the seventh frame data into one of the first frame data and the third frame data respectively and the third frame data and the first frame data respectively; and a second data flow switcher for receiving the fourth frame data and the fifth frame data and transforming the fourth frame data and the fifth frame data into one of the eighth frame data and the ninth frame data respectively and the eighth frame data and the ninth frame data respectively.

In a preferred embodiment of the present invention, the circuit further comprises a first data latch, coupled to and between the first data flow switcher and the first dual-port buffer, the first data flow switcher receiving the sixth frame data and the seventh frame data, and transforming the sixth frame data and the seventh frame data into one of a tenth frame data and the third frame data respectively and the third frame data and the tenth frame data respectively, the first data latch for receiving the tenth frame data and outputting the first frame data, the number of bits of the first frame data is larger than the number of bits of the tenth frame data; a second data latch, coupled to and between the first dual-port buffer and the signal converter, receiving the second frame data and outputting an eleventh frame data, the number of bits of the second frame data is larger than the number of bits of the eleventh frame data; wherein the signal converter, in response to the tenth frame data, the third frame data, and the eleventh frame data corresponding to the third frame data, obtaining the compensation data to output the fourth frame data and the fifth frame data.

In a preferred embodiment of the present invention, the circuit further comprises: a first nonlinear quantizer, coupled to and between the first data flow switcher and the first data latch, the first data flow switcher for receiving the sixth frame data and the seventh frame data, and transforming the sixth frame data and the seventh frame data into one of a twelfth frame data and the third frame data respectively and the third frame data and the twelfth frame data respectively, the first nonlinear quantizer for receiving the twelfth frame data and quantizing the twelfth frame data by using a nonlinear quantization method to output the tenth frame data; and a second nonlinear quantizer, coupled to and between the first data flow switcher and the signal converter, receiving the third frame data and quantizing the third frame data by using a nonlinear quantization method to output the thirteenth frame data; wherein the signal converter, in response to the twelfth frame data, the third frame data, and the thirteenth frame data corresponding to the eleventh frame data, obtains the compensation data to output the fourth frame data and the fifth frame data.

The present invention provides a circuit for enhancing motion picture quality, comprising: a first nonlinear quantizer for receiving a first frame data and quantizing the first frame data by using a nonlinear quantization method to output a second frame data; a second nonlinear quantizer for receiving a third frame data and quantizing the third frame data by using a nonlinear quantization method to output a fourth frame data a frame memory module, coupled to the first nonlinear quantizer, for receiving the second frame data and outputting a fifth frame data corresponding to the second frame data, the second frame data being shown in a motion picture after the fifth frame data; a signal converter, in response to the first frame data, the third frame data, the fourth frame data and the fifth frame data corresponding to the fourth frame data, for obtaining a compensation data to output a sixth frame data and a seventh frame data; a first data flow switcher for receiving an eighth frame data and a ninth frame data and transforming the eight frame data and the ninth frame data into one of the first frame data and the third frame data respectively and the third frame data and the first frame data respectively; and a second data flow switcher for receiving the sixth frame data and the seventh frame data and transforming the sixth frame data and the seventh frame data into one of the tenth frame data and the eleventh frame data respectively and the tenth frame data and the eleventh frame data respectively.

In a preferred embodiment of the present invention, the frame memory module comprises: a first dual-port buffer for receiving and temporarily storing the second frame date, and first-in-first-out outputting the second frame data; a second dual-port buffer for receiving and temporarily storing the fifth frame date, and first-in-first-out outputting the fifth frame data; a frame memory for storing a motion picture data; and a multiplexer unit coupled to said first dual-port buffer, said second dual-port buffer, and said frame memory; for selecting and transmitting one of said outputted said second frame data to said frame memory and said outputted said fifth frame data to said second dual-port buffer.

The present invention provides a method for enhancing motion picture quality, comprising: providing a first dual-port buffer, a second dual-port buffer, and a frame memory; using the first dual-port buffer to receive and temporarily store a first frame date, and first-in-first-out outputting the first frame data; using the second dual-port buffer to receive and temporarily store a second frame date, and first-in-first-out outputting the second frame data; the first frame data being shown in a motion picture after the second frame data; using the frame memory to store a motion picture data; multiplexing said motion picture data in said frame memory thereby selecting and transmitting one of said outputted said first frame data to said frame memory and said outputted said second frame data to said second dual-port buffer; and obtaining a compensation data to output a fourth frame data and a fifth frame data, in response to the first frame data, a third frame data, and the second frame data corresponding to the third frame data; transforming a sixth frame data and a seventh frame data into one of the first frame data and the third frame data respectively and the third frame data and the first frame data respectively, in response to a time sequence; and transforming the fourth frame data and the fifth frame data become one of an eighth frame data and a ninth frame data respectively and the ninth frame data and the eighth frame data respectively, in response to the time sequence.

The present invention uses a memory structure including a frame memory and two dual-port buffers. The memory structure can read the frame date of the previous frame and store the frame date of the present frame at the same time. Hence, the memory structure of the present invention is much simplified than the prior art. The present invention also effectively compresses the data so that the size of the frame memory can be reduced. The present invention also uses alternate reading/writing and interpolation by using the adjacent pixels to further reduce the size of the frame memory (less than ½ of the conventional frame memory).

The above is a brief description of some deficiencies in the prior art and advantages of the present invention.

Other features, advantages and embodiments of the invention will be apparent to those skilled in the art from the following description, accompanying drawings and appended claims.

### BRIEF DESCRIPTION OF DRAWINGS

FIG. 1 is a pixel of a conventional LCD.

FIG. 2 shows the relationship between the voltage applied to the liquid crystal capacitor of a pixel |V| and the frame time.

FIG. 3 shows the relationship between the gray level and the frame time for a pixel.

FIG. 4 shows the conventional method to improve the response delay on the LCD.

FIG. 5 shows the relationship between the gray level and the frame time for a pixel after the conventional method in FIG. 4 is applied.

FIG. 6 is a block diagram of a circuit for enhancing the motion picture quality in accordance with a preferred embodiment of the present invention.

FIG. 7 is a block diagram of a circuit for enhancing the motion picture quality in accordance with another preferred embodiment of the present invention.

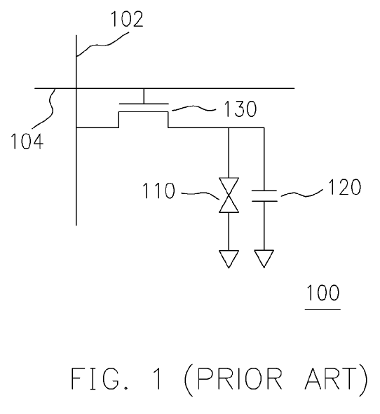

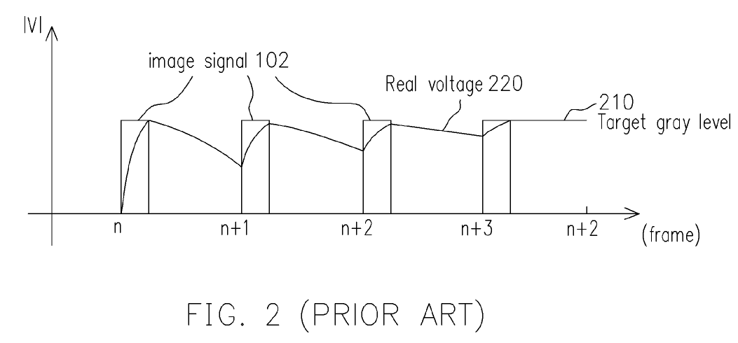

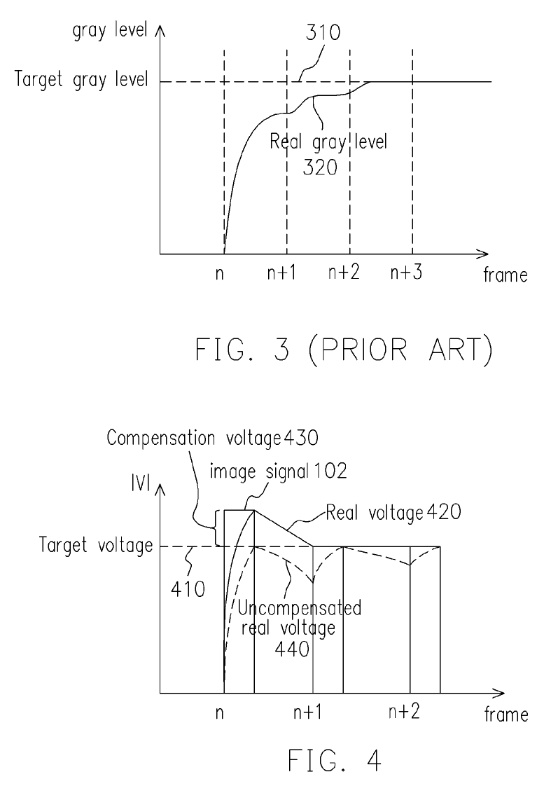

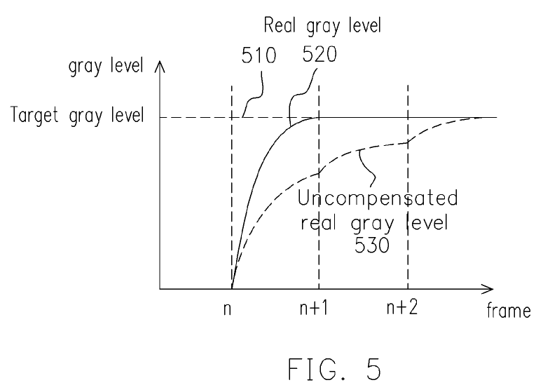

### DETAILED DESCRIPTION

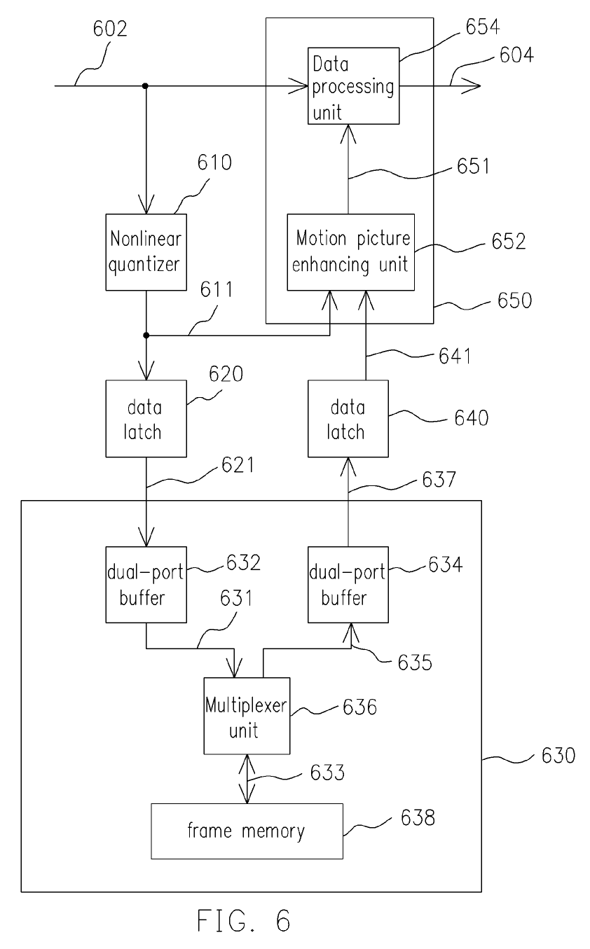

FIG. 6 is a block diagram of a circuit for enhancing the motion picture quality in accordance with a preferred embodiment of the present invention. The circuit includes a nonlinear quantizer 610, data latches 620 and 640, dual-port buffers 632 and 634, a multiplexer unit 636, a frame memory 638, a motion picture enhancing unit 652,and a data processing unit 654. This circuit can be applied to a LCD.

When playing a motion video, the nonlinear quantizer 610 receives a frame data 602 from a previous-level circuit such as image decoder. The frame data 602 is, for example pie, a 108 MHz stream data having RGB colors, and each color uses 8 bits to represent the data. The frame data 602 is converted by using a nonlinear quantization method to a frame data 611. The frame data 611 is, for example, a 108 MHz stream data having RGB colors, and each color uses 5 bits to represent the data. The nonlinear quantizer 610 can be implemented by a random only memory (ROM). The frame data 602 is inputted into the ROM as an address signal to read the quantized value stored in the ROM. This quantized value is the frame data 611.

The data latch 620 receives the frame data 611 from the nonlinear quantizer 610 and outputs the frame data 621. The frame data 621 is, for example, a 54 Mbps stream data having RGB colors, and each color uses 10 bits to represent the data. In this embodiment, the number of bits of the frame data 621 is 10; the number of bits of the frame data 611 is 5. That is, the number of bits of the frame data 621 is integral of the number of bits of the frame data 611.

The dual-port buffer 632 receives and temporarily stores the frame data 621, and outputs the frame data 631 based on the first-in-first-out rule. The frame data 631 is, for example, a 108 Mbps stream data having RGB colors, and each color uses 10 bits to represent the data. The dual-port buffer 634 receives and temporarily stores the frame data 635, and outputs the frame data 637 based on the first-in-first-out rule. The frame data 635 is, for example, a 108 Mbps stream data having RGB colors, and each color uses 10 bits to represent the data. The frame data 637 is, for example, a 54 Mbps stream data having RGB colors, and each color uses 10 bits to represent the data. The frame data 631 is shown in a motion picture after the frame data 635. The frame memory 638 stores the motion picture data. The multiplexer unit 636 is coupled to the dual-port buffers 632 and 634, and the frame memory 638. The multiplexer unit 636 will select to transmit the frame data 631 outputted from the buffer 632 to the frame memory 638, or transmit the frame data 635 outputted from the frame memory 638 to the buffer 634, based on the reading/writing time sequence.

This embodiment further includes data path controller (not shown) to control the reading/writing time sequence of the frame data 635, and the dual-port buffer 632 and 634, which makes the multiplexer unit 636 switch according to the time sequence of the memory. The clock signal for inputting/outputting data and the control signal of the data path controller for controlling the frame data 635 can be the same as the those for controlling the frame data 602; e.g., 108 Mbps. To match the time sequence of the data path controller for reading/writing, the size of the dual-port buffers 632 and 634 can be determined by the following equation: Size of the buffer<2×Delay for switching reading/writing×Number of switching×Data bandwidth.

The data latch 640 receives the frame data 637 from the dual-port buffer 632 and outputs the frame data 641. The frame data 641 is, for example, a 108 Mbps stream data having RGB colors, and each color uses 5 bits to represent the data. In this embodiment, the number of bits of the frame data 637 is 10; the number of bits of the frame data 641 is 5. That is, the number of bits of the frame data 637 is integral of the number of bits of the frame data 641.

The motion picture enhancing unit 652 simultaneously receives the frame data 611 and 641, and generates the compensation data 651 according to the difference between the frame data 611 and 641. This motion picture enhancing unit 652 can be implemented by a look-up table. The data processing unit 654 compensates the corresponding frame data 602 in response to the compensation data 651 to obtain the frame data 604. The frame data 604 is then sent to the next-level circuit.

In a second embodiment of the present invention, even if the nonlinear quantizer 610 and the motion picture enhancing unit 652 in FIG. 6 are not used so that the frame data 602 and 611 are the same signal, and the frame data 641 and 651 are the same signal, this circuit is still within the scope of the present invention. In a third embodiment of the present invention, the circuit omits the data latches 620 and 640 in the second embodiment, this circuit is still within the scope of the present invention. In addition, the signal converter 650 can also be replaced by the other units in the above embodiments.

Referring to FIG. 6, the fourth embodiment of the present invention is illustrated as follows. This circuit is similar to the circuit described in the first embodiment except that the memory structure of the frame memory module 630 is replaced with another structure. In the fourth embodiment of the present invention, the frame memory module 630 can be any structure having the ability to store the present frame data and output the previous frame data at the same time. In a fifth embodiment of the present invention, the data latches 620 and 640 in the fourth embodiment can be omitted.

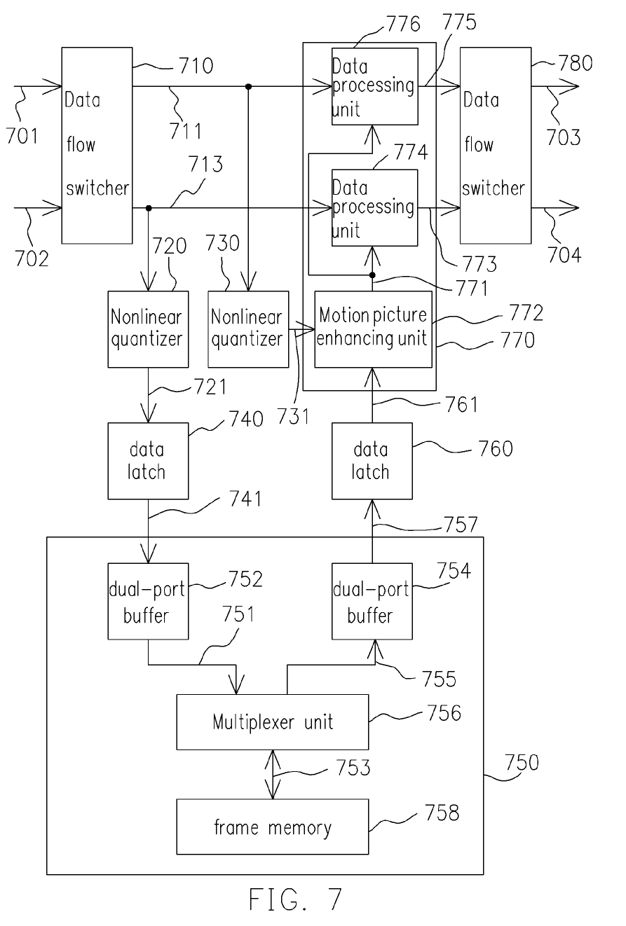

The present invention also uses alternate reading/writing and interpolation by using the adjacent pixels to further reduce the size of the frame memory. FIG. 7 is a block diagram of a circuit for enhancing the motion picture quality in accordance with the sixth embodiment of the present invention. The circuit includes data flow switchers 710 and 780, nonlinear quantizers 720 and 730, data latches 740 and 760, dual-port buffers 752 and 754, a multiplexer unit 756, a frame memory 758, a motion picture enhancing unit 772, and data processing units 774 and 776. This circuit can be applied to a LCD.

In this embodiment, when playing the motion video, the data flow switcher 710 receives the frame data from the previous-level circuit such as an image decoder and separates the frame data into odd frame data 701 and even frame data 702 according to the order of the stream. The frame data 701 and 702 are for example 54 MHz stream data having RGB colors, and each color uses 8 bits to represent the data. The data flow switcher 710 receives the frame data 701 and 702 and introduces them to be one of frame data 713 and 711 respectively.

The nonlinear quantizer 720 receives the frame data 713 and converts it by using a nonlinear quantization method to a frame data 721. The frame data 721 is, for example, a 54 MHz stream data having RGB colors, and each color uses 5 bits to represent the data. The nonlinear quantizers 720 and 730 can be implemented by random only memory. The frame data 713 and 711 are inputted into the ROM as address signals to read the quantized values stored in the ROM. The quantized values are the frame data 721 and 731.

The data latch 740 receives the frame data 721 and outputs the frame data 741. The frame data 741 is, for example, a 27 MHz stream data having RGB colors, and each color uses 10 bits to represent the data. That is, the number of bits of the frame data 741 is integral of the number of bits of the frame data 721.

The dual-port buffer 752 receives and temporarily stores the frame data 741, and outputs the frame data 751 based on the first-in-first-out rule. The frame data 631 is, for example, a 54 MHz stream data having RGB colors, and each color uses 10 bits to represent the data. The dual-port buffer 754 receives and temporarily stores the frame data 755, and outputs the frame data 757 based on the first-in-first-out rule. The frame data 757 is, for example, a 27 Mbps stream data having RGB colors, and each color uses 10 bits to represent the data. The frame data 755 is, for example, a 54 MHz stream data having RGB colors, and each color uses 10 bits to represent the data. The frame data 751 is shown in a motion picture after the frame data 757. The frame memory 758 stores the motion picture data. The multiplexer unit 756 is coupled to the dual-port buffers 752 and 754, and the frame memory 758. The multiplexer unit 756 will select to transmit the frame data 751 outputted from the buffer 752 to the frame memory 758, or transmit the frame data 753 outputted from the frame memory 758 to the buffer 754, based on the reading/writing time sequence.

The data latch 760 receives the frame data 757 and outputs the frame data 761. The frame data 761 is, for example, a 54 Mbps stream data having RGB colors, and each color uses 5 bits to represent the data. That is, the number of bits of the frame data 757 is integral of the number of bits of the frame data 761.

The motion picture enhancing unit 772 simultaneously receives the frame data 731 and 761, and generates the compensation data 771 according to the difference between the frame data 731 and 761. This motion picture enhancing unit 772 can be implemented by a look-up table. The data processing unit 774 compensates the corresponding frame data 713 in response to the compensation data 771 to obtain the frame data 773. The data processing unit 776 compensates the corresponding frame data 711 in response to the compensation data 771 to obtain the frame data 775. The data flow switcher 780 receives the frame data 775 and 773 and introduces them to be one of the frame data 704 and 703 respectively. The frame data 703 is the compensated odd frame data; the frame data 704 is the compensated even frame data. After combining the frame data 704 and 703, the combined frame data can be sent to the next-level circuit such as image driving circuit.

In a seventh embodiment of the present invention, even if the nonlinear quantizers 720 and 730, and the motion picture enhancing unit 772 in FIG. 7 are not used so that the frame data 713 and 721 are the same signal, and the frame data 761 and 771 are the same signal, this circuit is still within the scope of the present invention. In an eighth embodiment of the present invention, the circuit omits the data latches 740 and 760 in the seventh embodiment, the frame data 713 and 741 are the same signal and the frame data 757 and 761 are the same signal; this circuit is still within the scope of the present invention. In addition, the signal converter 770 can also be replaced by the other units in the above embodiments.

Referring to FIG. 7, the ninth embodiment of the present invention is illustrated as follows. This circuit is similar to the circuit described in the sixth embodiment except that the memory structure of the frame memory module 750 is replaced with another structure. In the ninth embodiment of the present invention, the frame memory module 750 can be any structure having the ability to store the present frame data and output the previous frame data at the same time. In a tenth embodiment of the present invention, the data latches 740 and 760 in the ninth embodiment can be omitted.

In the sixth, seventh, ninth, and tenth embodiments, the data processing units 776 and 774 compensate the frame data 711 and 713 with a same compensation data 771. But the frame data 713 also can be compensated according to the difference between the frame data 711 and 713.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A circuit for enhancing motion picture quality, comprising:
a first dual-port buffer, for receiving and temporarily storing a first frame date, and first-in-first-out outputting said first frame data;
a second dual-port buffer, for receiving and temporarily storing a second frame date, and first-in-first-out outputting said second frame data; said first frame data being shown in a motion picture after said second frame data;
a frame memory, for storing a motion picture data;
a multiplexer unit, coupled to said first dual-port buffer, said second dual-port buffer, and said frame memory, for selecting and transmitting one of said outputted said first frame data to said frame memory and said outputted said second frame data to said second dual-port buffer; and
a signal converter, for obtaining a compensation data to output a third frame data in response to said first frame data and said second frame data corresponding to said first frame data.

2. The circuit of claim 1, further comprising:
a first data latch, for receiving a fourth frame data and outputting said first frame data, the number of bits of said first frame data is larger than the number of bits of said fourth frame data;
a second data latch, for receiving a fifth frame data and outputting said second frame data, the number of bits of said second frame data is larger than the number of bits of said fifth frame data;
wherein said signal converter is for obtaining said compensation data to output said third frame data in response to said fourth frame data and said fifth frame data corresponding to said second frame data.

3. The circuit of claim 2, further comprising a nonlinear quantizer receiving a sixth frame data and quantizing said sixth frame data by using a nonlinear quantization method to output said fourth frame data, said signal converter receiving said sixth frame data and compensating said sixth frame data based on said compensation data to obtain said third frame data.

4. The circuit of claim 3, wherein said signal converter comprises:
a motion picture enhancing unit, for simultaneously receiving said fourth frame data and said fifth frame data and comparing said fourth frame data and said fifth frame data to generate said compensation data based on the difference between said fourth frame data and said fifth frame data; and
a data processing unit, for simultaneously receiving said sixth frame data and said compensation data corresponding to said sixth frame data, and compensating said sixth frame data based on said compensation data to obtain said third frame data.

5. The circuit of claim 2, wherein the number of bits of said first frame data are integral of the number of bits of said fourth frame data, and the number of bits of said second frame data are said integral of the number of bits of said fifth frame data.

6. The circuit of claim 1, wherein said circuit is applied to a liquid crystal display.

7. A circuit for enhancing motion picture quality, comprising:
a nonlinear quantizer receiving a first frame data and quantizing said first frame data by using a nonlinear quantization method to output a second frame data;
a frame memory module, coupled to said nonlinear quantizer, for receiving said second frame data and outputting a third frame data corresponding to said second frame data, said second frame data being shown in a motion picture after said third frame data; and
a signal converter, in response to said second frame data and said third frame data corresponding to said second frame data, for obtaining a compensation data to compensate said first frame data for outputting a fourth frame data.

8. The circuit of claim 7, wherein said frame memory module comprises:
a first dual-port buffer, for receiving and temporarily storing said second frame date, and first-in-first-out outputting said second frame data;
a second dual-port buffer, for receiving and temporarily storing said third frame date, and first-in-first-out outputting said third frame data;
a frame memory, for storing a motion picture data; and
a multiplexer unit, coupled to said first dual-port buffer, said second dual-port buffer, and said frame memory;
for selecting and transmitting one of said outputted said second frame data to said frame memory and said outputted said third frame data to said frame memory to said second dual-port buffer.

9. The circuit of claim 8, wherein said signal converter comprises:
a motion picture enhancing unit, for simultaneously receiving said second frame data and said third frame data and comparing said second frame data and said second frame data to generate said compensation data based on the difference between said second frame data and said third frame data; and
a data processing unit, for simultaneously receiving said first frame data and said compensation data corresponding to said first frame data, and compensating said first frame data based on said compensation data to obtain said fourth frame data.

10. The circuit of claim 8, wherein said circuit is applied to a liquid crystal display.

11. A method for enhancing motion picture quality, comprising:
providing a first dual-port buffer, a second dual-port buffer, and a frame memory;
using said first dual-port buffer to receive and temporarily store a first frame date, and first-in-first-out outputting said first frame data;
using said second dual-port buffer to receive and temporarily store a second frame date, and first-in-first-out outputting said second frame data; said first frame data being shown in a motion picture after said second frame data;
using said frame memory to store a motion picture data;
multiplexing said motion picture data in said frame memory thereby selecting and transmitting one of said outputted said first frame data to said frame memory and said outputted said second frame data to said second dual-port buffer; and
obtaining a compensation data to output a third frame data in response to said first frame data and said second frame data corresponding to said first frame data.

12. The method of claim 11, further comprising:
receiving a fourth frame data and outputting said first frame data, the number of bits of said first frame data is larger than the number of bits of said fourth frame data;
receiving a fifth frame data and outputting said second frame data, the number of bits of said second frame data is larger than the number of bits of said fifth frame data;
wherein said step of outputting said third frame data is performed by obtaining said compensation data in response to said fourth frame data and said fifth frame data corresponding to said second frame data.

13. The method of claim 12, further comprising quantizing said sixth frame data by using a nonlinear quantization method to output said fourth frame data, wherein said step of outputting said third frame data further comprises:
simultaneously receiving said fourth frame data and said fifth frame data and comparing said fourth frame data and said fifth frame data to generate said compensation data based on the difference between said fourth frame data and said fifth frame data; and
simultaneously receiving said sixth frame data and said compensation data corresponding to said sixth frame data, and compensating said sixth frame data based on said compensation data to obtain said third frame data.

14. The method of claim 11, further comprising quantizing said fourth frame data by using a nonlinear quantization method to output said first frame data, wherein said step of outputting said third frame data further comprises:
simultaneously receiving said first frame data and said second frame data and comparing said first frame data and said second frame data to generate said compensation data based on the difference between said first frame data and said second frame data; and
simultaneously receiving said fourth frame data and said compensation data corresponding to said fourth frame data, and compensating said fourth frame data based on said compensation data to obtain said third frame data.

15. A circuit for enhancing motion picture quality, comprising:
a first dual-port buffer receiving and temporarily storing a first frame date, and first-in-first-out outputting said first frame data;
a second dual-port buffer, for receiving and temporarily storing a second frame date, and first-in-first-out outputting said second frame data; said first frame data being shown in a motion picture after said second frame data;
a frame memory, for storing a motion picture data;
a multiplexer unit, coupled to said first dual-port buffer, said second dual-port buffer, and said frame memory, for selecting and transmitting one of said outputted said first frame data to said frame memory and said outputted said second frame data to said second dual-port buffer;
a signal converter, in response to said first frame data, a third frame data and said second frame data corresponding to said third frame data, for obtaining a compensation data to output a fourth frame data and a fifth frame data;
a first data flow switcher, for receiving a sixth frame data and a seventh frame data and transforming said sixth frame data and said seventh frame data into one of said first frame data and said third frame data respectively and said third frame data and said first frame data respectively; and
a second data flow switcher, for receiving said fourth frame data and said fifth frame data and transforming said fourth frame data and said fifth frame data into one of said eighth frame data and said ninth frame data respectively and said eighth frame data and said ninth frame data respectively.

16. The circuit of claim 15, further comprising:
a first data latch, coupled to and between said first data flow switcher and said first dual-port buffer, said first data flow switcher receiving said sixth frame data and said seventh frame data, and transforming said sixth frame data and said seventh frame data into one of a tenth frame data and said third frame data respectively and said third frame data and said tenth frame data respectively, said first data latch, for receiving said tenth frame data and outputting said first frame data, the number of bits of said first frame data is larger than the number of bits of said tenth frame data;
a second data latch, coupled to and between said first dual-port buffer and said signal converter, for receiving said second frame data and outputting an eleventh frame data, the number of bits of said second frame data is larger than the number of bits of said eleventh frame data;
wherein said signal converter, in response to said tenth frame data, said third frame data and said eleventh frame data corresponding to said third frame data, obtains said compensation data to output said fourth frame data and said fifth frame data.

17. The circuit of claim 16, further comprising:
a first nonlinear quantizer, coupled to and between said first data flow switcher and said first data latch, said first data flow switcher receiving said sixth frame data and said seventh frame data, and transforming said sixth frame data and said seventh frame data into one of a twelfth frame data and said third frame data respectively and said third frame data and said twelfth frame data respectively, said first nonlinear quantizer receiving said twelfth frame data and quantizing said twelfth frame data by using a nonlinear quantization method to output said tenth frame data; and
a second nonlinear quantizer, coupled to and between said first data flow switcher and said signal converter, for receiving said third frame data and quantizing said third frame data by using a nonlinear quantization method to output said thirteenth frame data;
wherein said signal converter, in response to said twelfth frame data, said third frame data, and said thirteenth frame data corresponding to said eleventh frame data, obtains said compensation data to output said fourth frame data and said fifth frame data.

18. The circuit of claim 17, wherein said signal converter comprises:
a motion picture enhancing unit, for simultaneously receiving said thirteenth frame data and said eleventh frame data and comparing said thirteenth frame data and said eleventh frame data to generate said compensation data based on the difference between said thirteenth frame data and said eleventh frame data;
a first data processing unit, for simultaneously receiving said twelfth frame data and said compensation data corresponding to said twelfth frame data, and compensating said twelfth frame data based on said compensation data to obtain said fourth frame data; and
a second data processing unit, for simultaneously receiving said third frame data and said compensation data corresponding to said third frame data, and compensating said third frame data based on said compensation data to obtain said fifth frame data.

19. The circuit of claim 16, wherein the number of bits of said first frame data are integral of the number of bits of said tenth frame data, and the number of bits of said second frame data are said integral of the number of bits of said eleventh frame data.

20. The circuit of claim 15, wherein said circuit is applied to a liquid crystal display.

21. A circuit for enhancing motion picture quality, comprising:
a first nonlinear quantizer, for receiving a first frame data and quantizing said first frame data by using a nonlinear quantization method to output a second frame data;
a second nonlinear quantizer, for receiving a third frame data and quantizing said third frame data by using a nonlinear quantization method to output a fourth frame data
a frame memory module, coupled to said first nonlinear quantizer, receiving said second frame data and outputting a fifth frame data corresponding to said second frame data, said second frame data being shown in a motion picture after said fifth frame data;
a signal converter, in response to said first frame data, said third frame data, said fourth frame data and said fifth frame data corresponding to said fourth frame data, for obtaining a compensation data to output a sixth frame data and a seventh frame data;
a first data flow switcher, for receiving an eighth frame data and a ninth frame data and transforming said eight frame data and said ninth frame data into one of said first frame data and said third frame data respectively and said third frame data and said first frame data respectively; and
a second data flow switcher, for receiving said sixth frame data and said seventh frame data and transforming said sixth frame data and said seventh frame data into one of said tenth frame data and said eleventh frame data respectively and said tenth frame data and said eleventh frame data respectively.

22. The circuit of claim 21, wherein said frame memory module comprises:
a first dual-port buffer, for receiving and temporarily storing said second frame date, and first-in-first-out outputting said second frame data;
a second dual-port buffer, for receiving and temporarily storing said fifth frame date, and first-in-first-out outputting said fifth frame data;
a frame memory storing a motion picture data; and
a multiplexer unit, coupled to said first dual-port buffer, said second dual-port buffer, and said frame memory;
for selecting and transmitting one of said outputted said second frame data to said frame memory and said outputted said fifth frame data to said second dual-port buffer.

23. The circuit of claim 22, wherein said signal converter comprises:
a motion picture enhancing unit, for simultaneously receiving said fourth frame data and said fifth frame data and comparing said fourth frame data and said fifth frame data to generate said compensation data based on the difference between said fourth frame data and said fifth frame data;
a first data processing unit, for simultaneously receiving said first frame data and said compensation data corresponding to said first frame data, and compensating said first frame data based on said compensation data to obtain said sixth frame data; and
a second data processing unit, for simultaneously receiving said third frame data and said compensation data corresponding to said third frame data, and compensating said third frame data based on said compensation data to obtain said seventh frame data.

24. The circuit of claim 21, wherein said circuit is applied to a liquid crystal display.

25. A method for enhancing motion picture quality, comprising:
providing a first dual-port buffer, a second dual-port buffer, and a frame memory;
using said first dual-port buffer to receive and temporarily store a first frame date, and first-in-first-out outputting said first frame data;
using said second dual-port buffer to receive and temporarily store a second frame date, and first-in-first-out outputting said second frame data; said first frame data being shown in a motion picture after said second frame data;
using said frame memory to store a motion picture data;
multiplexing said motion picture data in said frame memory thereby selecting and transmitting one of said outputted said first frame data to said frame memory and said outputted said second frame data to said second dual-port buffer; and
obtaining a compensation data to output a fourth frame data and a fifth frame data, in response to said first frame data, a third frame data, and said second frame data corresponding to said third frame data;
transforming a sixth frame data and a seventh frame data into one of said first frame data and said third frame data respectively and said third frame data and said first frame data respectively, in response to a time sequence; and
transforming said fourth frame data and said fifth frame data into one of an eighth frame data and a ninth frame data respectively and said ninth frame data and said eighth frame data respectively, in response to said time sequence.

26. The method of claim 25, further comprising:
receiving a tenth frame data and outputting said first frame data, wherein a number of bits of said tenth frame data is larger than a number of bits of said first frame data;
receiving a second frame data and outputting an eleventh frame data, wherein a number of bits of said second frame data is larger than a number of bits of said eleventh frame data;
wherein said step of outputting said fourth frame data and said fifth frame data is performed by obtaining said compensation data in response to said third frame data, said tenth frame data, and said eleventh frame data corresponding to said tenth frame data;
wherein said step of transforming said sixth frame data and said seventh frame data into one of said first frame data and said third frame data respectively and said third frame data and said first frame data respectively is changed to a step of transforming said sixth frame data and said seventh frame data into one of said tenth frame data and said third frame data respectively and said third frame data and said tenth frame data respectively.

27. The method of claim 26, further comprising quantizing a twelfth frame data and said third frame data by using a nonlinear quantization method to output said tenth frame data and a thirteenth frame data respectively, wherein said step of outputting said fourth frame data and said fifth frame data is performed by obtaining said compensation data in response to said twelfth frame data, said third frame data, and said thirteenth frame data corresponding to said eleventh frame data, and wherein said step of transforming said sixth frame data and said seventh frame data into one of said tenth frame data and said third frame data respectively and said third frame data and said tenth frame data respectively is change to a step of transforming said sixth frame data and said seventh frame data into one of said twelfth frame data and said third frame data respectively and said third frame data and said twelfth frame data respectively.

28. The method of claim 27, wherein said step of outputting said fourth frame data and said fifth frame data further comprises:
simultaneously receiving said thirteenth frame data and said eleventh frame data corresponding to said thirteen and comparing said thirteenth frame data and said eleventh frame data to generate said compensation data based on the difference between said thirteenth frame data and said eleventh frame data;
simultaneously receiving said twelfth frame data and said compensation data corresponding to said twelfth frame data, and compensating said twelfth frame data based on said compensation data to obtain said fourth frame data; and
simultaneously receiving said third frame data and said compensation data corresponding to said third frame data, and compensating said third frame data based on said compensation data to obtain said fifth frame data.

29. The method of claim 25, further comprising quantizing a tenth frame data and said third frame data by using a nonlinear quantization method to output said first frame data and an eleventh frame data respectively;
wherein said step of outputting said fourth frame data and said fifth frame data is performed by obtaining said compensation data in response to said tenth frame data, said third frame data, and said eleventh frame data, and said second frame data corresponding to said eleventh frame data;
wherein said step of transforming a sixth frame data and a seventh frame data into one of said first frame data and said third frame data respectively and said third frame data and said first frame data respectively is changed to a step of transforming said sixth frame data and said seventh frame data into one of said tenth frame data and said third frame data respectively and said third frame data and said tenth frame data respectively.

30. The method of claim 29, wherein said step of outputting said fourth frame data and said fifth frame data further comprises:
simultaneously receiving said eleventh frame data and said second frame data corresponding to said eleventh and comparing said eleventh frame data and said second frame data to generate said compensation data based on the difference between said eleventh frame data and said second frame data;
simultaneously receiving said tenth frame data and said compensation data corresponding to said tenth frame data, and compensating said tenth frame data based on said compensation data to obtain said fourth frame data; and
simultaneously receiving said third frame data and said compensation data corresponding to said third frame data, and compensating said third frame data based on said compensation data to obtain said fifth frame data.
